(19) United States
(12) Patent Application Publication
(10) Pub. No.: US 2021/0016350 A1
(43) Pub. Date: Jan. 21, 2021

(54) PREHEAT DYED BUILD MATERIALS WITH PREHEATING SOURCES

(71) Applicant: HEWLETT-PACKARD DEVELOPMENT COMPANY, L.P., Spring, TX (US)

(72) Inventors: Alex Veis, Netanya (IL); Joaquim Brugue Garvi, Sant Cugat del Valles (ES); Esteve Comas Cespedes, Sant Cugat del Valles (ES)

(21) Appl. No.: 16/608,269

(22) PCT Filed: Apr. 10, 2018
(86) PCT No.: PCT/US2018/026836

§ 371 Date: Oct. 25, 2019

(51) Int. Cl. B22F 3/00; B33Y 10/00; B33Y 30/00; B33Y 50/02; B29C 64/165; B29C 64/295; B29C 64/393

(52) U.S. Cl. CPC B22F 3/008; B33Y 10/00; B33Y 30/00; B29K 2995/002; B29C 64/165; B29C 64/295; B29C 64/393; B33Y 50/02

(57) ABSTRACT

An example of an additive manufacturing system is disclosed. The example disclosed herein comprises a build material distributor, a color module, a preheating source, and a controller. The build material distributor is to form build material layers. The color module is to eject a composition that dyes a build material layer with a color. The preheating source is to emit energy at a wavelength related to the dyed build material color so that at least a 40% of the energy is absorbed by the dyed build material. The controller is to receive printing instructions to print a 3D object, wherein the printing instructions define an area to be fused in a build material layer. The controller is also to instruct the build material distributor to form the build material layer. The controller is to instruct the color module to eject the composition to color the build material from the build material layer in a zone comprising the area to be fused. The controller is further to control the preheating source to emit energy to preheat the build material layer.

### BACKGROUND

Some three-dimensional printing systems apply a fusing agent over areas of successive layers of un-solidified build material, such as powdered or particulate-type build material, followed by exposure to fusing energy to selectively melt layers of a part of a three-dimensional object that is to be generated. The un-solidified powder may be preheated before the application of fusing agent.

### BRIEF DESCRIPTION OF THE DRAWINGS

The present application may be more fully appreciated in connection with the following detailed description taken in conjunction with the accompanying drawings, in which like reference characters refer to like parts throughout and in which:

FIG. 1 is a block diagram illustrating an example of an additive manufacturing system to preheat dyed build materials with preheating sources.

FIG. 2A is a block diagram illustrating an example of a preheating source.

FIG. 2B is a block diagram illustrating another example of a preheating source.

FIG. 3A is a block diagram illustrating an example of a zone comprising an area to be fused.

FIG. 3B is a block diagram illustrating another example of a zone comprising an area to be fused.

FIG. 3C is a block diagram illustrating another example of a zone comprising an area to be fused.

FIG. 3D is a block diagram illustrating another example of a zone comprising an area to be fused.

FIG. 4 is a block diagram illustrating another example of an additive manufacturing system to preheat dyed build materials with preheating sources.

FIG. 5 is a block diagram illustrating another example of an additive manufacturing system to preheat dyed build materials with preheating sources.

FIG. 6 is a block diagram illustrating another example of an additive manufacturing system to preheat dyed build materials with preheating sources.

FIG. 7 is a flowchart of an example method for preheating dyed build materials with preheating sources.

FIG. 8 is a flowchart of another example method for preheating dyed build materials with preheating sources.

FIG. 9 is a block diagram illustrating an example of a processor-based system to preheat dyed build materials with preheating sources.

### DETAILED DESCRIPTION

The following description is directed to various examples of the disclosure. In the foregoing description, numerous details are set forth to provide an understanding of the examples disclosed herein. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the scope of the examples. Throughout the present disclosure, the terms “a” and “an” are intended to denote at least one of a particular element. In addition, as used herein, the term “includes” means includes but not limited to, the term “including” means including but not limited to. The term “based on” means based at least in part on.

Some three-dimensional printing techniques may apply, for example by printing or jetting, an energy absorbing fusing agent over areas of successive layers of an un-solidified build material. According to one example, a suitable build material may be PA12 build material commercially known as V1R10A “HP PA12” available from HP Inc. Each layer may then be exposed to fusing energy to selectively melt layers of a part of a three-dimensional object that is to be generated.

One example of the present disclosure provides an additive manufacturing system that comprises a build material distributor to form build material layers. The additive manufacturing system further comprises a color module to eject a composition that is different from the fusing agent to color a build material layer with a color for the purposes of pre-heating the build material close to but below the melting point of the build material. The additive manufacturing system also comprises a preheating source to emit energy at a wavelength related to the dyed build material color, so that at least 40% of the wavelength is absorbed by the dyed build material. The system further comprises a controller to receive printing instructions to print a three dimensional (3D) object, wherein the printing instructions define an area to be fused in a build material layer; to instruct the build material distributor to form the build material layer; to instruct the color module to eject the composition to color the build material from the build material layer in a zone comprising the area to be fused; and to control the preheating source to emit energy to preheat the build material layer.

Another example of the present disclosure provides a method comprising a plurality of operations to be performed. The method comprises receiving printing instructions to print a 3D object, wherein the printing instructions define an area to be fused in a build material layer. The method also comprises forming the build material layer, by a build material distributor. The method comprises ejecting, by a color module, a composition that is different from the fusing agent to dye the build material from the build material layer in a zone comprising the area to be fused in a color for the purposes of preheating the build material dose to but below the melting point of the build material. The method further comprises preheating, by a preheating source, the build material layer by emitting energy at a wavelength related to the dyed build material color to the build material layer, so that at least 40% of the wavelength is absorbed by the dyed build material. The method also comprises ejecting, by a fusing agent distributor, fusing agent to the build material layer based on the printing instructions. The method further comprises applying energy, for example by a fusing lamp, to the build material layer. In the present disclosure, the fusing lamp and the preheating source are different and separate entities,

Another example of the present disclosure provides a non-transitory machine readable medium storing instructions executable by a processor. The non-transitory machine-readable medium comprises instructions to receive printing instructions to print a 3D object, wherein the printing instructions define an area to be fused in a build material layer. The non-transitory machine readable medium also comprises instructions to form the build material layer by a build material distributor. The non-transitory machine readable medium also comprises instructions to eject, by a color module, a composition that is different from the fusing agent to color the build material from the build material layer in a zone comprising the area to be fused in a color for the purposes of preheating the build material below the melting point of the build material. The non-transitory machine readable medium further comprises instructions to preheat, by an preheating source, the build material layer by emitting energy at a wavelength related to the dyed build material color to the build material layer, so that at least 40% of the wavelength is absorbed by the dyed build material. The non-transitory machine readable medium also comprises instructions to eject, by a fusing distributor, fusing agent to the build material layer based on the printing instructions. The non-transitory machine readable medium further comprises instructions to heat, by a fusing lamp, the build material layer. In the present disclosure, the fusing lamp and the preheating source are different and separate entities.

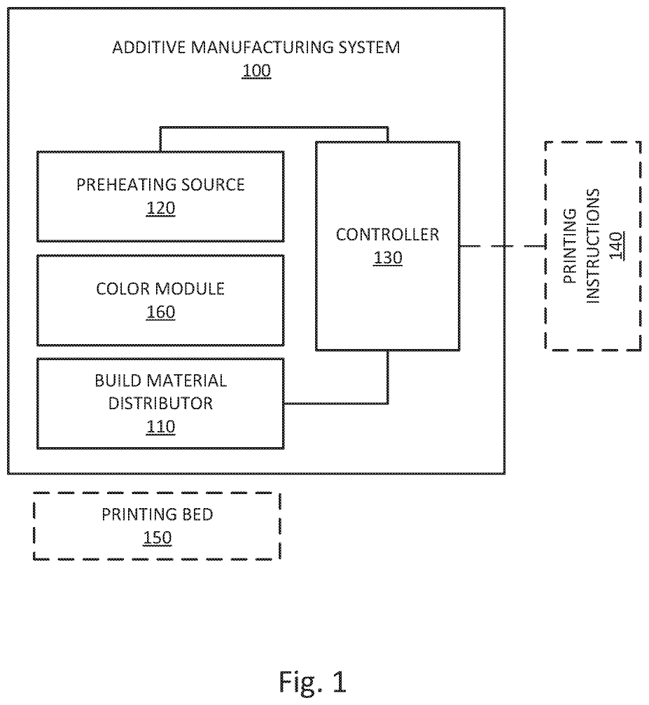

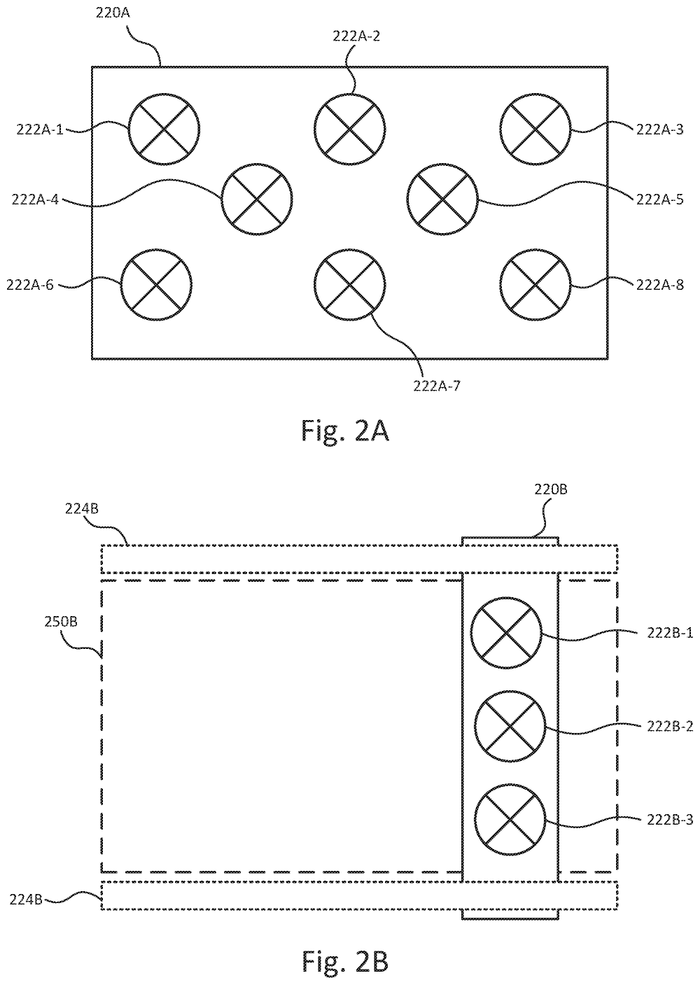

Referring now to the figures, FIG. 1 is a block diagram illustrating an example of an additive manufacturing system 100 to preheat dyed build materials with preheating sources. The system 100 comprises a build material distributor 110, a color module 160, and a preheating source 120. The build material distributor 110 may be understood as any mechanism (e.g., printing roller, printing wiper, etc.) to form build material layers. In an example, the build material distributor 110 may form a build material layer on a printing bed 150. The printing bed 150 may be internal or removable from the additive manufacturing system 100 (e.g., the printing bed may not be present when the printer is shipped). The printing bed 150 may be a surface to receive build material from the build material distributor 110 in the form of, for example, build material layers having a generally uniform thickness. The generally uniform thickness may range from about 80 microns to about 120 microns, or bigger or smaller. The color module 160 is to eject a composition that is different from the fusing agent that dyes a build material layer in a color. In an example, the composition ejected by the color module may be printing agent composition that may comprise, for example, a dye or pigments, The preheating source 120 is to emit energy at a wavelength wherein at least 40% of the wavelength is absorbed by the dyed build material. In the present disclosure, the term “a wavelength” may be understood as a single wavelength, or as a narrow band wavelength. In an example, the preheating source 120 is an array comprising one or more LED lights to emit energy at a wavelength, wherein each LED light may be individually controllable to emit energy at a wavelength. Other examples of preheating source 120 may be laser, laser diodes, laser arrays, and the like. More examples of the preheating source 120 are disclosed in FIG. 2A, and FIG. 2B. The system 100 further comprises a controller 130 in connection with the build material distributor 110 and the preheating source 120. The controller connection may be by means of a physical wire and/or wireless. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein.

When illuminated, colored bodies reflect or absorb some of the illuminating wavelengths. Leveraging the color of a body to be illuminated (e.g., by applying certain color dyes to the build material) in conjunction with the energy wavelength band from the preheating source (e.g., preheating source light) may lead to said illuminated body to absorb a bigger amount of the incoming energy. Precisely, bodies with colors that can absorb substantially the totality of a narrow band preheating source emissions may lead to high energy-efficient systems. This may substantially reduce the energy reflected (wasted) by the colored bodies and therefore enabling the design of energy-efficient heating systems, for example, an energy-efficient build material preheating system. In an example, a yellow body absorbs at least the 40% of a preheating source that emits energy at a wavelength comprised in the range defined from 450 nanometers (nm) to 495 nm, for example a blue light. Therefore, following this example, a system (e.g., system 100) comprising a build material layer having a yellow color, and an preheating source (e.g., preheating source 120) emitting blue light may be an energy-efficient system to pre-heat said yellow build material. In another example, an orange body absorbs at least the 40% of a preheating source that emits energy at a wavelength comprised in the range defined from 450 nanometers (nm) to 495 nm, for example a blue light. Therefore, following this example, a system (e.g., system 100) comprising a build material layer having an orange color, and a preheating source (e.g., preheating source 120) emitting blue light may be an energy-efficient system to pre-heat said orange build material. In yet another example, a white body (e.g., Titanium Dioxide) absorbs at least the 40% of a preheating source that emits energy at a wavelength of less than 400 nanometers (nm), for example Ultraviolet (UV) light. Therefore, following this example, a system (e.g., system 100) comprising a build material layer having a white color, and a preheating source (e.g., preheating source 120) emitting UV light may be an energy-efficient system to pre-heat said white build material. In the present disclosure the term “UV light” may be understood in its broad spectrum as it may comprise Ultraviolet A (UVA) wavelengths, ranging from about 315 nm to about 400 nm; Ultraviolet B (UVB) wavelengths, ranging from about 280 nm to about 315 nm; Ultraviolet C (UVC) wavelengths, ranging from about 100 nm to about 380 nm; and/or any other UV wavelength. Other combinations from build material color and preheating source energy wavelengths may be defined without departing from the scope of the present disclosure.

As an example, the preheating source is to emit energy at a wavelength related to the dyed build material color so that at least 40% of the energy is absorbed by the dyed build material. As an additional example, the preheating source is to emit energy at a wavelength related to the dyed build material color so that at least 50% of the energy is absorbed by the dyed build material. As an additional example, the preheating source is to emit energy at a wavelength related to the dyed build material color so that at least 60% of the energy is absorbed by the dyed build material. As an additional example, the preheating source is to emit energy at a wavelength related to the dyed build material color so that at least 90% of the energy is absorbed by the dyed build material. As an additional example, the preheating source is to emit energy at a wavelength related to the dyed build material color so that at least 98% of the energy is absorbed by the dyed build material.

As used herein, the term “about” is used to provide flexibility to a numerical range endpoint by providing that a given value may be, for example, an additional 15% more or an additional 15% less than the endpoints of the range. The degree of flexibility of this term can be dictated by the particular variable and would be within the knowledge of those skilled in the art to determine based on experience and the associated description herein.

The controller 130 is to receive printing instructions 140 to print a 3D object, wherein the printing instructions 140 define an area to be fused in a build material layer. The printing instructions 140 to print a 3D object may be derived from a 3D object model of a 3D object. An example of a 3D object model may be generated using a Computer Aided Design (CAD) application which is a tool that may be used to create precision drawings or technical illustrations. Another example of a 3D model may be a Computer Aided Manufacturing (CAM) application which is a tool that may be used to design products such as electronic circuit boards in computers and other devices. The 3D printing instructions may be instructions that, for example, describe at which locations on a powder bed drops of different print agents should be printed. Some examples of printing agents are fusing agents and detailing agents. A 3D object model may be defined in vector type format, and 2D rasterized images may be generated from this each representing slices of the object model. Each slice may then be processed to determine how printing agents should be printed to generate a layer of an object corresponding to the slice. The 3D printing instructions 140 define the 3D object to print by, for example, defining the plurality of slices of said object to be generated. Each slice may determine a cross-sectional area and/or a cross-sectional shape of the 3D object to be produced by the additive manufacturing apparatus 100 and determines the print agents that should be printed thereon. The cross-sectional area and/or the cross-sectional shape, may be the areas to be fused. Therefore, a slice from the plurality of slices may define which sections of the build material layer may need to be fused to print the 3D object.

The controller 130 is to instruct the build material distributor to form the build material layer. The build material layer may be formed on top of the printing bed 150 and it is a layer comprised of build material. The build material may be an un-solidified powder that may be, for example, nylon powder. In an example, the build material used is the commercially available powder and has white color 40% These is an example and other build material colors may be used without departing from the scope of the present disclosure.

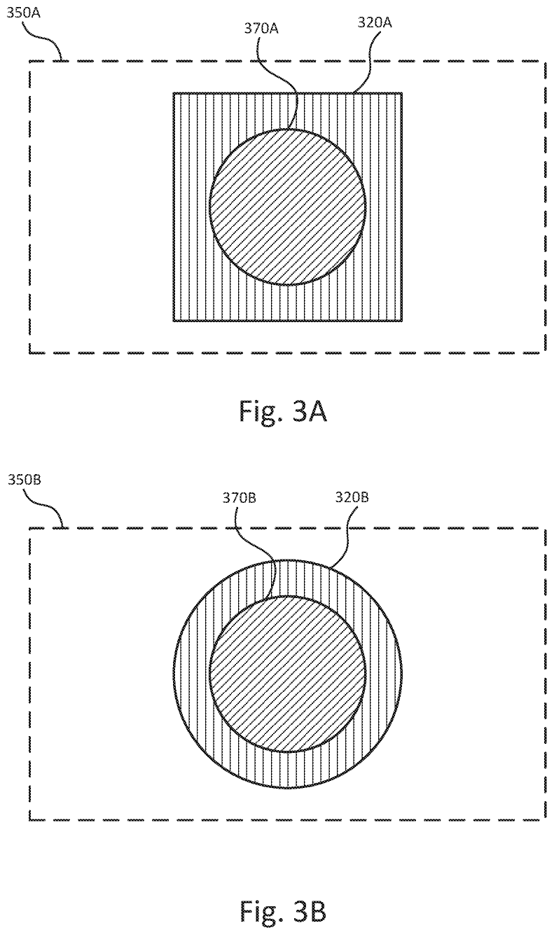

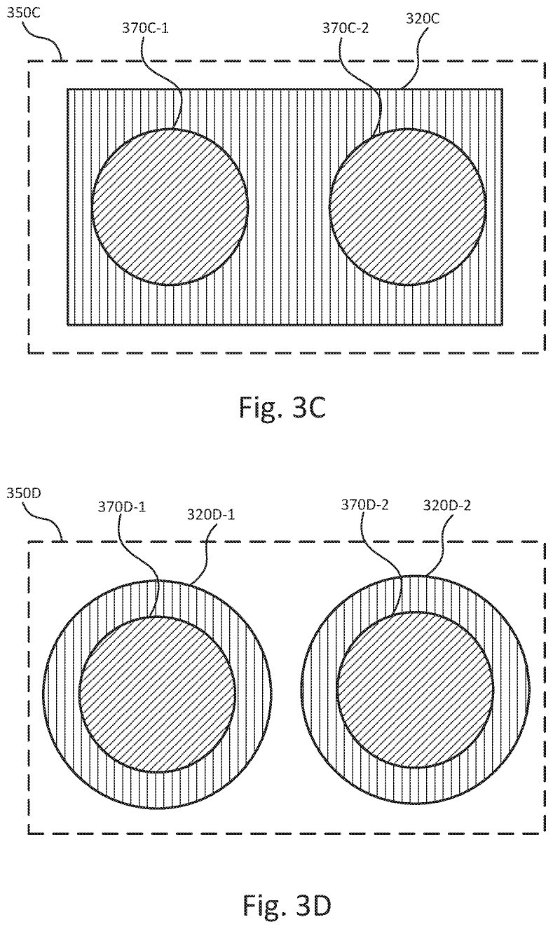

The controller 130 is to instruct the color module 160 to eject the composition to color the build material from the build material layer in a zone comprising the area to be fused. The zone comprising the area to be fused comprises the total surface of the area to be fused and may further comprise an additional surface of the build material layer that is not to be fused. A plurality of examples of the zone comprising the area to be fused are disclosed in further detail in FIG. 3A-3D. The color module 160 may eject a composition different from fusing agent that dyes the zone comprising the area to be fused in the build material layer in a color that absorbs at least a 40% of the energy wavelengths, upon preheating source 120 illumination. The purpose of preheating the build material zone comprising the area to be fused is to raise the temperature of said area of build material below but near its melting point. The area from the build material layer other than the zone comprising the area to be fused may not absorb as much energy, and may not be heated significantly. For example, the color module 160 may comprise one or more printheads to apply the composition to the zone comprising the area to be fused from the build material layer.

The energy used to preheat the build material may depend on the color of the build material. Therefore, having a one comprising the area to be fused in a build material bed in the appropriate color may lead to an energy-efficient system. However, commercially available powders may not have said appropriate color (e.g., commercially available white powder). Because of that, the color module 160 may dye the zone comprising the area to be fused from a commercially available powder build material layer in a color that, when illuminated by the preheating source 120, the energy emitted may be absorbed by at least a 40%. In an example, the color module 160 may dye the zone comprising the area to be fused in the build material layer, for example in yellow color. In another example, the color module 160 may dye the zone comprising the area to be fused of the build material layer in orange color. In another example, the color module 460 may dye the zone comprising the area to be fused in the build material layer in white color. In yet another example, the color module 160 may dye the zone comprising the area to be fused in the build material layer in other colors wherein said colors, upon illumination with a narrow band preheating source (e.g., preheating source 120), the colored particles absorb at least a 40% of the energy emitted by the preheating source. These are examples and other build material color dyes may be used without departing from the scope of the present disclosure.

The controller 130 is to control the preheating source 120 to emit energy to preheat the build material layer. In the present disclosure the preheating stage may be understood as heating the build material layer, by for example preheating source 120 irradiation, up to the point that the build material of the zone comprising the area to be fused temperature is close but below the melting point of the build material

FIG. 2A-2B illustrate examples of preheating sources. FIG. 2A is a block diagram illustrating an example of a preheating source according to an implementation. The preheating source may be a LED array 220A. The LED array 220A may be the same or similar as the preheating source 120 from FIG. 1. The LED array 220A is a two-dimensional (2D) static overhead array and comprises a plurality of LEDs therein. In the example, the LED array 220A comprises a first LED 222A-1, a second LED 222A-2, a third LED 222A-3, a fourth LED 222A-4, a fifth LED 222A-5, a sixth LED 222A-6, a seventh LED 222A-7, and an eighth LED 222A-8. The eight LEDs from the LED array 220A may be referred hereinafter as the plurality of LEDs (222A-1-222A-8). This is an example, and arrays comprising more or less LEDs can be derived therefrom without departing from the scope of the present disclosure. The plurality of LEDs from the LED array 220A are to emit energy that spans substantially the full width and length of the build material layer on the printing bed 250A and are controllable to emit energy to the build material layer. In the example, the plurality of LEDs are installed on the surface of the LED array 220A, however other layouts can be derived therefrom.

In an example, one LED from the plurality of LEDs (222A-1-222A-8) may be a blue LED, wherein the blue LED has a wavelength comprised in the range defined from about 450 nm to about 495 nm. In another example, each LED from the plurality of LEDs may be a blue LED, wherein the blue LED has a wavelength comprised in the range defined from about 450 nm to about 495 nm. In another example, one LED from the plurality of LEDs (222A-1-222A-8) may be a UV LED, wherein the UV LED has a wavelength of less than 400 nm. In yet another example, each LED from the plurality of LEDs may be a UV LED, wherein the UV LED has a wavelength of less than about 400 nm. These are examples and other LED colors, and/or LED color combinations, may be used without departing from the scope of the present disclosure.

A controller (e.g., controller 130 from FIG. 1) may control the plurality of LEDs (222A-1-222A-8) to emit energy to preheat the build material layer on the printing bed 250A. In one example, the build material layer may be the area below the LED array 220A, then the controller may activate the plurality of LEDs (222A-1-222A-8) to irradiate said area.

FIG. 2B is a block diagram illustrating another example of a preheating source. The preheating source may be a LED array 220B. The LED array 220B may be the same as, or similar to, the preheating source 120 from FIG. 1. In an example, the LED array 220B is a one-dimensional (1D) array and comprises a plurality of LEDs therein. In another example, the LED array 220B is a 2D array and comprises a plurality of LEDs therein. In the example, the LED array 220B comprises a first LED 222B-1, a second LED 222B-2, and a third LED 222B-3. The three LEDs from the LED array 220B may be referred hereinafter as the plurality of LEDs (222B-1-222B-3). This is an example, and arrays comprising more or less LEDs can be derived therefrom without departing from the scope of the present disclosure. The plurality of LEDs from the LED array 220B are to emit energy that spans substantially the full width of the build material layer on the printing bed 250B and are controllable to emit energy to the build material layer. The LED array 220B may be movable along the length of the build material layer on the printing bed 250B by moving means 224B. The moving means 224B may be any mechanism that allows the LED array 220B to move along the length of the build material layer on the printing bed 250B in a controlled manner. In an example, the moving means 224B may comprise a guide and an engine, wherein the LED array 220B is movable through the guide and the engine controls said movement based on the instructions of a controller (e.g., controller 130 from FIG. 1). Other examples of moving means, such as a movable carriage, may be used without departing from the scope of the disclosure. In the example, the plurality of LEDs (2226-1-222B-3) are placed throughout the length of the LED array 220B, however other layouts can be derived therefrom.

In one example, one LED from the plurality of LEDs (2226-1-222B-3) may be a blue LED light, wherein the blue LED has a wavelength comprised in the range defined from about 450 nm to about 495 nm. In another example, each LED from the plurality of LEDs may be a blue LED light, wherein the blue LED has a wavelength comprised in the range defined from about 450 nm to about 495 nm. In another example, one LED from the plurality of LEDs (222B-1 222B-3) may be a UV LED, wherein the UV LED has a wavelength of less than 400 nm. In yet another example, each LED from the plurality of LEDs may be a UV LED, wherein the UV LED has a wavelength of less than about 400 nm. These are examples and other LED colors, and/or LED color combinations, may be used without departing from the scope of the present disclosure.

A controller (e.g., controller 130 from FIG. 1) may control the plurality of LEDs (222B-1-222B-3) to emit energy to preheat a zone comprising the build material layer, The controller may also control the LED array 220B movement along the length of the build material layer on the printing bed 250B. The controller may activate the LEDs to irradiate the zone comprising the build material layer. In an example, the area comprising the build material layer may be the area below the LED array 220B and the LED array 220B may be in the starting position as drawn in FIG. 2B, then the controller may activate the LED array 222B at the starting point and may move the LED array 220B along the length of the printing bed 250B, the controller may deactivate the LED array 222B when said LED does not irradiate the build material layer anymore. This is an example, and more examples can be derived therefrom.

FIG. 3A-3D illustrate examples of a zone comprising an area to be fused. FIG. 3A is a block diagram illustrating an example of a zone comprising an area to be fused. The build material layer on the printing bed 350A comprises an area to be fused 370A and a preheating zone 320A comprising the area to be fused. The preheating zone 320A may be the same as, or similar to the zone comprising the area to be fused referred in FIG. 1, and may be defined by a controller based on 3D printing instructions. A color module (e.g., color module 160 from FIG. 1) is to eject the composition to color the build material in the preheating zone 320A before the preheating and fusing operations. The area to be fused 370A may be defined by 3D printing instructions (e.g., printing instructions 140 from FIG. 1) and may be the area in which droplets of fusing agent may be ejected thereon. The printing bed 350A may be similar or the same as the printing bed 150 from FIG. 1. The preheating zone 320A comprises the area to be fused 370A and may also comprise part of the build material layer that is not to be fused. In the example, the preheating zone 320A has substantially a rectangular shape, wherein the area to be fused 370A is substantially placed in the middle. A preheating source (e.g., preheating source 120 from FIG. 1) may be controlled by a controller (e.g., controller 130 from FIG. 1) to emit energy to preheat the building bed 350A comprising the preheating zone 320A.

FIG. 3B is a block diagram illustrating another example of a zone comprising an area to be fused. The build material layer on the printing bed 350B comprises an area to be fused 370B and a preheating zone 320B comprising the area to be fused. The preheating zone 320B may be the same as, or similar to the zone comprising the area to be fused referred in FIG. 1, and may be defined by a controller based on 3D printing instructions. A color module (e.g., color module 160 from FIG. 1) is to eject the composition to color the build material in the preheating zone 320B before the preheating and fusing operations. The area to be fused 370B may be defined by 3D printing instructions (e.g., printing instructions 140 from FIG. 1) and may be the area in which droplets of fusing agent may be ejected thereon. The printing bed 350B may be similar or the same as the printing bed 150 from FIG. 1. The preheating zone 320B comprises the area to be fused 370B and may also comprise part of the build material layer that is not to be fused. In the example, the preheating zone 320B has a similar shape as the area to be fused 370B but extended (covering a greater surface), wherein the area to be fused 370B is substantially placed in the middle. In some implementations, the preheating zone 320B may have coarsely pixelated shape depending on the ejecting precision of the color module. The extension of the preheating zone 320B with respect to the area to be fused 370B may vary depending on the example. In an example the preheating zone 320B extends by a predetermined distance around the perimeter of the area to be fused 370B. In another example, the preheating zone 320B may not extend the area to be fused 370B, therefore the preheating zone 320B, and the area to be fused 370B being substantially covering the same area. More examples can be derived without departing from the scope of the present disclosure. A preheating source (e.g., preheating source 120 from FIG. 1) may be controlled by a controller (e.g., controller 130 from FIG. 1) to emit energy to preheat the printing bed 350B comprising the preheating zone 320B.

FIG. 3C is a block diagram illustrating another example of a zone comprising an area to be fused. The build material layer on the printing bed 350C comprises a first area to be fused 370C-1 and a second area to be fused 370C-2 and a single preheating zone 320C comprising the first area to be fused 370C-1 and the second area to be fused 370C-2. The preheating zone 320C may be the same as, or similar to the zone comprising the area to be fused referred in FIG. 1, and may be defined by a controller based on 3D printing instructions. A color module (e.g., color module 160 from FIG. 1) is to eject the composition to color the build material in the preheating zone 320A before the preheating and fusing operations. The first area to be fused 370C-1 and the second area to be fused 370C-2 may be defined by 3D printing instructions (e.g., printing instructions 140 from FIG. 1) and may be the area in which droplets of fusing agent may be ejected thereon. The printing bed 350C may be similar or the same as the printing bed 150 from FIG. 1. The preheating zone 320C comprises the first area to be fused 370C-1 and the second area to be fused 370C-2; and may also comprise part of the build material layer that is not to be fused. In the example, the preheating zone 320C has substantially a rectangular shape, wherein the area to be fused 370C-1 is substantially placed in the middle of a first half of the preheating zone 320C, and the second area to be fused 370C-2 is substantially placed in the middle of a second half of the preheating zone 320C. A preheating source (e.g., preheating source 120 from FIG. 1) may be controlled by a controller (e.g., controller 130 from FIG. 1) to emit energy to preheat the printing bed 350C comprising the preheating zone 320C.

FIG. 3D is a block diagram illustrating another example of a zone comprising an area to be fused. The build material layer on the printing bed 350D comprises a first area to be fused 370D-1, a second area to be fused 370D-2, a first preheating zone 320D-1 comprising the first area to be fused, and a second preheating zone 320D-2 comprising the second area to be fused. The first preheating zone 320D-1 and the second preheating zone 320D-2 may be the same as, or similar to the zone comprising the area to be fused referred in FIG. 1, and may be defined by a controller based on 3D printing instructions. A color module (e.g., color module 160 from FIG. 1) is to eject the composition to color the build material in the preheating zone 320D before the preheating and fusing operations. The first area to be fused 370D-1 and the second area to be fused 370D-2 may be defined by 30 printing instructions (e.g., printing instructions 140 from FIG. 1) and may be the areas in which droplets of fusing agent may be ejected thereon. The printing bed 350D may be similar or the same as the printing bed 150 from FIG. 1. The first preheating 320D-1 comprises the first area to be fused 370D-1 and may also comprise part of the build material layer that is not to be fused. Likewise, the second preheating zone 320D-2 comprises the second area to be fused 370D-2 and may also comprise part of the build material layer that is not to be fused. In the example, the first preheating zone 320D-1 has a similar shape as the area to be fused 370D-1 but extended (covering a greater surface), wherein the first area to be fused 370D-1 is substantially placed in the middle. In some implementations, the preheating zone 320D-1 may have coarsely pixelated shape depending on the ejecting precision of the color module. The extension of the first preheating zone 320D-1 with respect to the first area to be fused 370D-1 may vary depending on the example. In an example, the first preheating zone 320D-1 extends by a predetermined distance around the perimeter of the first area to be fused 370D-1. In another example, the first preheating 320D-1 may not extend the first area to be fused 370D-1, therefore the first preheating zone 320D-1, and the first area to be fused 370D-1 being substantially covering the same area. Similar description may apply to the second preheating zone 320D-2, and the second area to be fused 370D-2. More examples can be derived without departing from the scope of the present disclosure. A preheating source (e.g., preheating source 120 from FIG. 1) may be controlled by a controller (e.g., controller 130 from FIG. 1) to emit energy to preheat the printing bed 350D comprising the first preheating zone 320D-1, and the second preheating zone 320D-2.

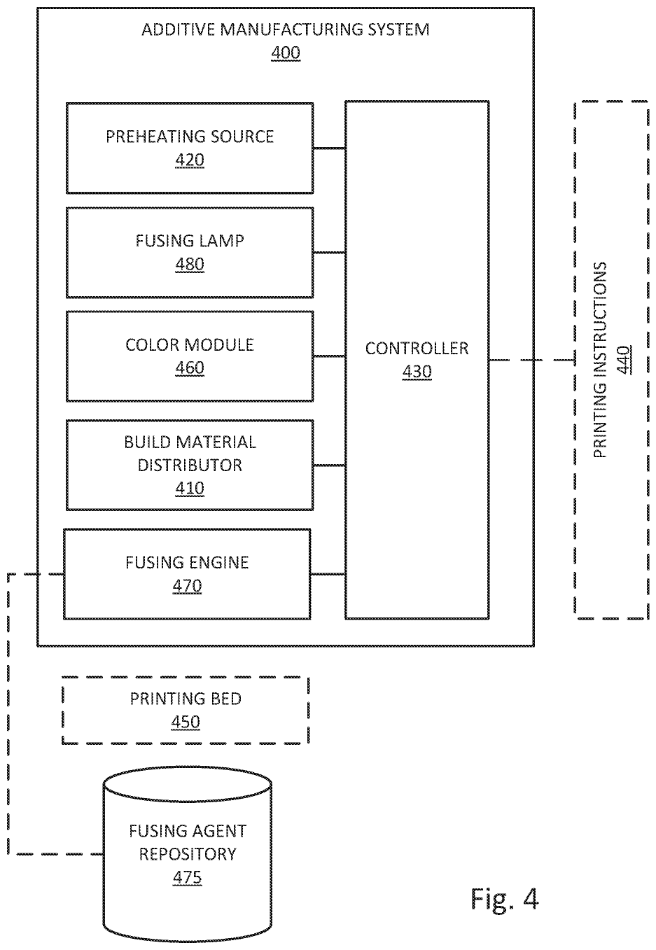

FIG. 4 is a block diagram illustrating another example of an additive manufacturing system 400 to preheat dyed build materials with preheating sources according to an example. The system 400 comprises a build material distributor 410, a color module 460, a preheating source 420, a fusing distributor 470, and a fusing lamp 480. The build material distributor 510 may be the same as or similar to the build material distributor 110 from FIG. 1. The color module 460 may be the same as or similar to the color module 160 from FIG. 1. The preheating source 420 may be the same as or similar to the preheating source 120 from FIG. 1. The build material distributor 410 may be understood as any mechanism (e.g., printing roller, printing wiper, etc.) to form build material layers. In an example, the build material distributor 410 may form a build material layer on a printing bed 450. The printing bed 450 may be internal or removable from the additive manufacturing system 400 (e.g., the printing bed may not be present when the printer is shipped). The printing bed 450 may be a surface to receive build material from the build material distributor 410 in the form of, for example, build material layers having a generally uniform thickness. The generally uniform thickness may range from about 80 microns to about 120 microns, or bigger or smaller. The color module 460 is to eject a composition that is different from the fusing agent that dyes a build material layer in a color. In an example, the composition ejected by the color module may be a printing agent composition that may comprise, for example, a dye or pigments. The preheating source 420 is to emit energy at a wavelength wherein at least 40% of the wavelength is absorbed by the dyed build material. The purpose of the preheating source 420 is to raise the temperature of the dyed build material below but near its melting point. The build material bed 450 may be the same as or similar to the build material bed 150 from FIG. 1. The preheating source 420 may be an array comprising one or more LED lights to emit energy. Other examples of preheating source 420 may be laser, laser diodes, laser arrays, and the like. The fusing distributor 470 is to eject fusing agent to the build material layer. The fusing lamp 480 is to heat the build material layer to fuse those portions of the layer on which fusing agent was deposited by raising the temperature of the dyed build material above its melting point. The fusing lamp 480 may be a separate entity as the preheating source 420. As an example, a fusing lamp may be made of Tungsten and may comprise resistive heaters that may irradiate the printing bed 450 by a wide band of energy wavelengths. The system 400 further comprises a controller 430 in connection with the build material distributor 410, the color module 460, the preheating source 420, the fusing distributor 470, and the fusing lamp 480. The controller 430 may receive printing instructions 540 and may have the same functionality as the controller 130 that receives the printing instructions 140 from FIG. 1. The controller connection may be by means of a physical wire and/or wireless. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein.

The fusing agent is a composition that may be applied to the build material layer. In an example, the fusing agent may be a printing liquid composition. When a suitable amount of energy (e.g., energy irradiated by fusing lamp 580) is applied to the combination of build material and fusing agent, said energy may cause the combination of build material and fusing agent to heat up above the melting point and to fuse and solidify. In some examples, the build material may comprise metal build material powder to metal 3D printing, the fusing agent may further comprise a chemical binder system to bind the 3D metal particles in the fusing operation by the fusing engine. The fusing agent may be stored in a fusing agent repository 475 connected to the fusing distributor 470. In the example, the fusing agent repository 475 is outside the additive manufacturing system 400, however other system examples may include the fusing agent repository 470.

According to one example, a suitable fusing agent may be an ink-type formulation comprising carbon black, such as, for example, the fusing agent formulation commercially known as V10600 “HP fusing agent” available from HP Inc. In one example such a fusing agent may additionally comprise an infra-red light absorber. In one example such an ink may additionally comprise a near infra-red light absorber. In one example such a fusing agent may additionally comprise a visible light absorber. In one example such an ink may additionally comprise a UV light absorber. Examples of inks comprising visible light enhancers are dye based colored ink and pigment based colored ink, such as inks commercially known as CE039A and CE042A available from HP Inc.

The controller 430 is to receive printing instructions 440 and derive the area to be fused in the build material layer therefrom. The controller 430 may instruct the build material distributor 410 to form the build material layer, and instruct the color module 460 to eject the composition to color the build material in the zone comprising the area to be fused. The controller 430 may also control the preheating source 420 to preheat the build material layer. The controller 430 may further instruct the fusing distributor to eject fusing agent to the build material layer based on the printing instructions 440. The printing instructions 440 may define the areas to be fused, and the controller may instruct the fusing distributor to eject fusing agent to said areas to be fused on the build material layer. The controller 430 may also instruct the fusing lamp 480 to heat the build material layer to heat up above the melting point to fuse the combination of build material and fusing agent and solidify.

An example of fusing operation has been disclosed, however different fusing operations may be applied. For example, some alternative fusing processes may be Selective Laser Sintering (SLS), Selective Laser Melting (SLM) and/or Direct Metal Laser Sintering (DMLS), which are an additive manufacturing technique designed to use a high power-density laser to melt and fuse metallic powders together.

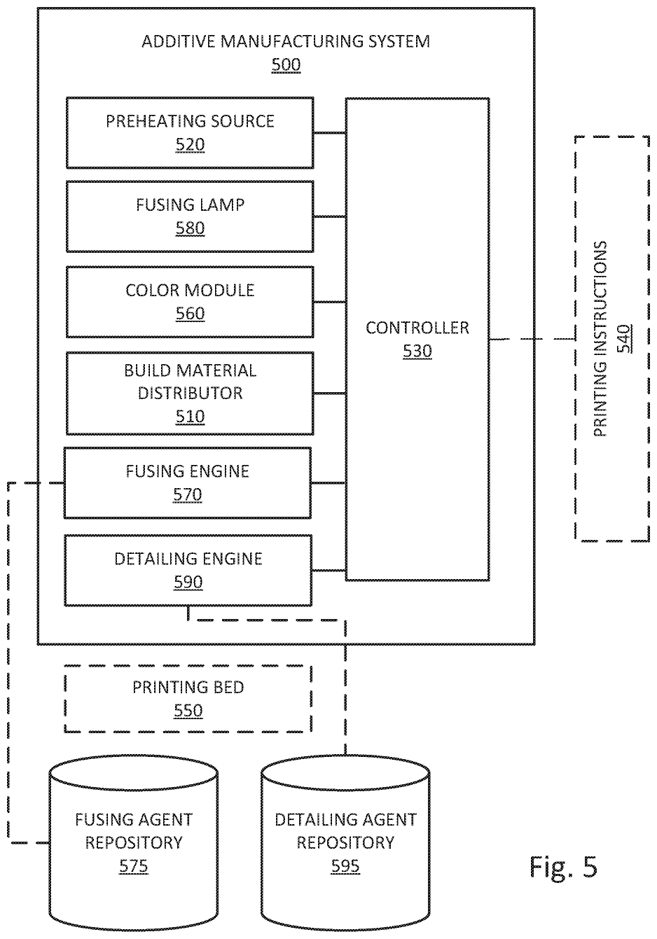

FIG. 5 is a block diagram illustrating another example of an additive manufacturing system 500 to preheat dyed build materials with preheating sources according to an example. The system 500 comprises a build material distributor 510, a color module 560, an preheating source 520, a fusing distributor 570, a detailing engine 590, and a fusing lamp 580. The build material distributor 510 may be the same or similar as the build material distributor 110 from FIG. 1. The color module 560 may be the same as or similar to the color module 160 from FIG. 1. The preheating source 520 may be the same as or similar to the preheating source 120 from FIG. 1. The build material distributor 510 may be understood as any mechanism (e.g., printing roller, printing wiper, etc.) to form build material layers. In an example, the build material distributor 510 may form a build material layer on a printing bed 550. The printing bed 550 may be internal or removable from the additive manufacturing system 500 (e.g., the printing bed may not be present when the printer is shipped). The printing bed 550 may be a surface to receive build material from the build material distributor 510 in the form of, for example, build material layers having a generally uniform thickness. The generally uniform thickness may range from about 80 microns to about 120 microns, or bigger or smaller. The color module 560 is to eject a composition that is different from the fusing agent that dyes a build material layer in a color. In an example, the composition ejected by the color module may be a printing agent composition that may comprise, for example, a dye or pigment. The preheating source 520 is to emit energy at a wavelength wherein at least 40% of the wavelength is absorbed by the build material. The build material bed 550 may be the same or similar as the building printing bed 150 from FIG. 1. The preheating source 520 may be an array comprising one or more LED lights to emit energy at a wavelength. Other examples of preheating source 520 may be laser, laser diodes, laser arrays, and the like. The fusing distributor 570 is to eject fusing agent to the build material layer. The fusing distributor 570 may have the same functionality as the fusing distributor 470 from FIG. 4. The detailing engine 590 is to eject detailing agent to the build material layer. The fusing lamp 580 is to heat the build material layer to fuse those portions of the layer on which fusing agent was deposited by raising the temperature of the dyed build material above its melting point. The fusing lamp 580 may be a separate entity as the preheating source 520. As an example, a fusing lamp may be made of Tungsten and may comprise resistive heaters that may irradiate the printing bed 550 by a wide band of energy wavelengths. The system 500 further comprises a controller 530 in connection with the build material distributor 510, the color module 560, the preheating source 520, the fusing distributor 570, the detailing agent 590, and the fusing lamp 580. The controller 530 may receive printing instructions 540 and may have the same functionality as the controller 130 that receives the printing instructions 140 from FIG. 1. The controller connection may be by means of a physical wire and/or wireless. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein.

The fusing agent is a composition that may be applied to the build material layer. In an example, the fusing agent may be a printing liquid composition. When a suitable amount of energy (e.g., energy irradiated by fusing lamp 580) is applied to the combination of build material and fusing agent, said energy may cause the combination of build material and fusing agent to heat up above the melting point and to fuse and solidify. In some examples, the build material may comprise metal build material powder to metal 3D printing, the fusing agent may further comprise a chemical binder system to bind the 3D metal particles in the fusing operation by the fusing engine. The detailing agent is another composition that may be applied to the build material layer before applying energy to fuse the build material and the fusing agent. The detailing agent may provide temperature control, for example, around the boundaries of areas printed with the fusing agent, or may modulate the effect of the fusing agent. If the amount of irradiation and temperature are not properly controlled, too much of the printed areas and surrounding un-solidified build material from the build material layer may melt, or the printed areas may not melt sufficiently. For example, when a printed area is selectively melted, smaller areas may tend to cool faster than larger areas, resulting in potentially weaker mechanical properties in the smaller areas. The detailing agent may include, for example, a clear liquid, or liquid of a single or different colors. According to one example, a suitable detailing agent may be a formulation commercially known as V1Q61A “HP detailing agent” available from HP Inc. The fusing agent may be stored in a fusing agent repository 575 connected to the fusing distributor 570. The detailing agent may be stored in a detailing agent repository 595 connected to the detailing engine 590. In the example, the fusing agent repository 575 and the detailing agent repository 595 are outside the additive manufacturing system 500, however other system examples may include the fusing agent repository 575 and/or the detailing agent repository 595.

The controller 530 is to receive printing instructions 540 and derive the area to be fused in the build material layer therefrom. The controller 530 may instruct the build material distributor 510 to form the build material layer, and instruct the color module 560 to eject the composition to color the build material in the zone comprising the area to be fused. The controller 530 may also control the preheating source 520 to preheat the build material layer. The controller 530 may further instruct the fusing distributor to eject fusing agent to the build material layer based on the printing instructions 540. The printing instructions 540 may define the areas to be fused, and the controller may instruct the fusing distributor 570 to eject fusing agent to said areas to be fused on the build material layer. The controller 530 may further instruct the detailing engine 590 to eject detailing agent to the build material layer based on the printing instructions 540. In an example, the detailing agent may be ejected in the boundaries of the fusing agent. The controller 530 may also instruct the fusing lamp 580 to heat the build material layer to heat up above the melting point to fuse the combination of build material and fusing agent and solidify.

An example of fusing operation has been disclosed, however different fusing operations may be applied. For example, some alternative fusing processes may be Selective Laser Sintering (SLS), Selective Laser Melting (SLM) and/or Direct Metal Laser Sintering (DMLS), which are an additive manufacturing technique designed to use a high power-density laser to melt and fuse metallic powders together.

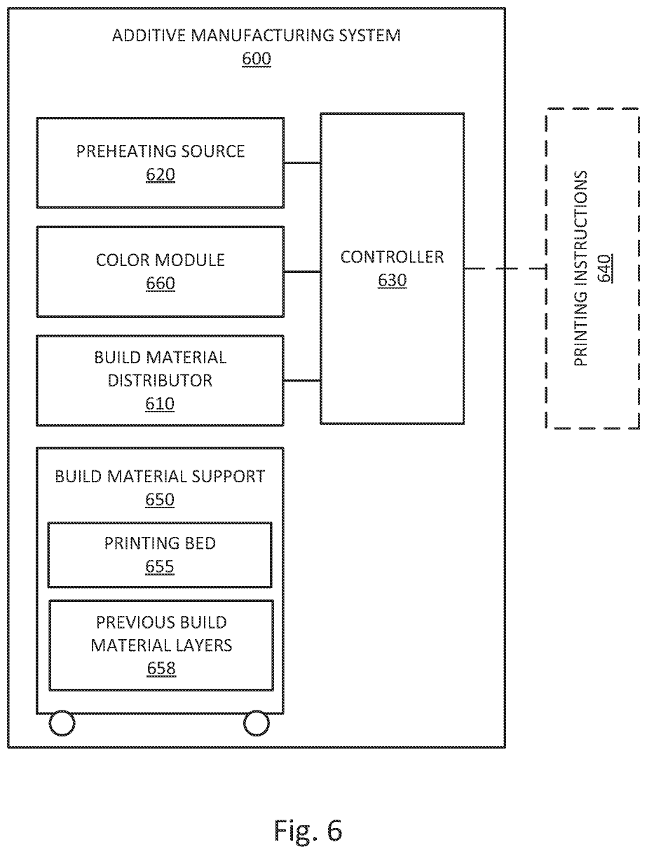

FIG. 6 is a block diagram illustrating another example of an additive manufacturing system 600 to preheat dyed build materials with preheating sources according to an example. The system 600 comprises a build material distributor 610, a color module 660, an preheating source 620, and a build material support 650. The build material support 650 may comprise a printing bed 655. In the examples the additive manufacturing system 600 is in operation, the build material support 650 may further comprise the previously build material layers 658. The build material distributor 610 may be the same or similar as the build material distributor 110 from FIG. 1. The color module 660 may be the same or similar as the color module 160 from FIG. 1. The preheating source 620 may be the same or similar as the preheating source 120 from FIG. 1. The build material distributor 610 may be understood as any mechanism (e.g., printing roller, printing wiper, etc.) to form build material layers. In an example, the build material distributor 610 may form a build material layer on the printing bed 655. The printing bed 655 may be a surface to receive build material from the build material distributor 610 in the form of, for example, build material layers having generally uniform thickness. The generally uniform thickness may range from about 80 microns to about 120 microns, or bigger or smaller. The color module 660 is to eject a composition that is different from the fusing agent that dyes a build material layer in a color. In an example, the composition ejected by the color module may be a printing agent composition that may comprise, for example, a dye or a pigment. The preheating source 620 is to emit energy at a wavelength wherein at least 40% of the wavelength is absorbed by the build material. The preheating source 620 may be an array comprising one or more LED lights to emit energy at a wavelength. Other examples of preheating source 620 may be laser, laser diodes, laser arrays, and the like. The system 600 further comprises a controller 630 in connection with the build material distributor 610, and the preheating source 620. In some examples, the controller 630 may also be connected to the build material support 650. The controller 630 may receive printing instructions 640 and may have the same functionality as the controller 130 that receives the printing instructions 140 from FIG. 1. The controller connection may be by means of a physical wire and/or wireless. The term “controller” as used herein may include a series of instructions encoded on a machine-readable storage medium and executable by a single processor or a plurality of processors. Additionally, or alternatively, a controller may include one or more hardware devices including electronic circuitry, for example a digital and/or analog application-specific integrated circuit (ASIC), for implementing the functionality described herein.

The build material support 650 may be a modular device that may be installed in the additive manufacturing system 600. In one example, the build material support 650 may be permanently installed in the additive manufacturing system 600. In another example, the build material support 650 may be attached and detached from the additive manufacturing system 600 by means of a moving mechanism, for example, wheels installed under the bottom surface of the build material support 650, The build material support 650 comprises the printing bed 655 wherein the build material layer can be formed by the build material distributor 610. The build material support 650 may further comprise previously built material layers 658 wherein previously printed layers from the 3D object to be printed may be stored.

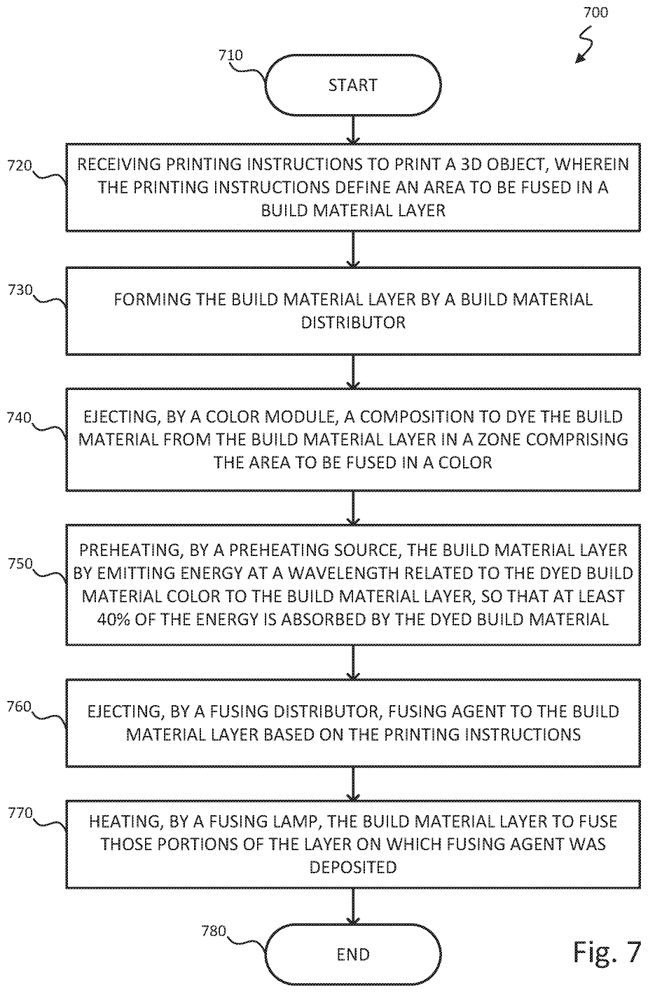

FIG. 7 is a flowchart of an example method 700 for preheating dyed build materials with preheating sources according to an example. Method 700 may be described below as being executed or performed by an apparatus, such as apparatus 100 of FIG. 1. Various other suitable systems may be used as well, such as, for example apparatus 400 of FIG. 4, apparatus 500 of FIG. 5, and apparatus 600 from FIG. 6. Method 700 may be implemented in the form of executable instructions stored on a machine-readable storage medium and executed by a single processor or a plurality of processors of the apparatus 100, and/or in the form of any electronic circuitry, for example digital and/or analog ASIC. In some implementations of the present disclosure, method 700 may include more or less blocks than are shown in FIG. 7. In some implementations, one or more of the blocks of method 800 may, at certain times, be ongoing and/or may repeat,

The method 700 may start at block 710, and continue to block 720, where a controller (e.g., controller 130 from FIG. 1) may receive printing instructions (e.g., printing instructions 140 from FIG. 1) to print a 3D object, wherein the printing instructions define an area to be fused in the build material layer, At block 730, a build material distributor (e.g., build material distributor 110 from FIG. 1) forms the build material layer. At block 740, a color module (e.g., color module 160 from FIG. 1), ejects a composition to color the build material from the build material layer in a zone comprising the area to be fused. At block 750, a preheating source (e.g., preheating source 120 from FIG. 1) preheats the build material layer by emitting energy at a wavelength related to the dyed build material color to the build material layer, so that at least 40% of the energy is absorbed by the dyed build material. At block 760, a fusing distributor (e.g., fusing distributor 470 from FIG. 4) ejects fusing agent to the build material layer based on the printing instructions. At block 770, a fusing lamp (e.g., fusing lamp 480 from FIG. 4) heats the build material layer to fuse those portions of the layer on which fusing agent was deposited by raising the temperature of the dyed build material above its melting point. At block 780, the method 700 may end. Method 700 may be repeated multiple times to build the 3D object, each time being printed a subsequent layer.

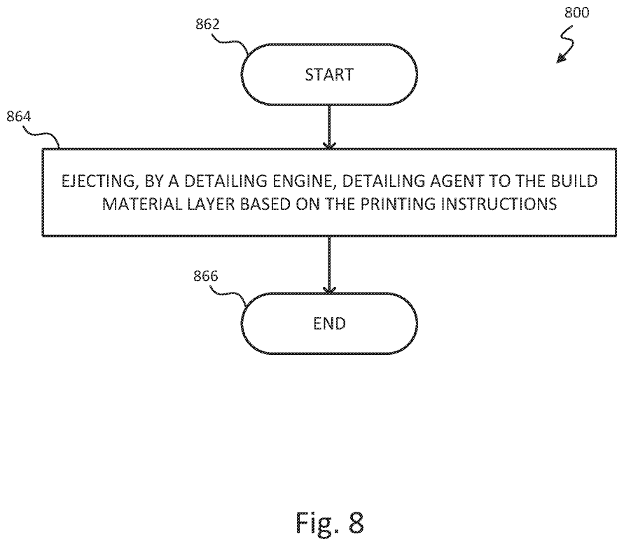

FIG. 8 is a flowchart of another example method 800 for preheating dyed build materials with preheating sources according to an example. Method 800 may be a sub-method from method 700 of FIG. 7 by adding an additional block, for example after block 760. Method 800 may be described below as being executed or performed by an apparatus, such as apparatus 100 of FIG. 1. Various other suitable systems may be used as well, such as, for example apparatus 400 of FIG. 4, apparatus 500 of FIG. 5, and apparatus 600 from FIG. 6. Method 800 may be implemented in the form of executable instructions stored on a machine-readable storage medium and executed by a single processor or a plurality of processors of the apparatus 100, and/or in the form of any electronic circuitry, for example digital and/or analog ASIC. In some implementations of the present disclosure, method 800 may include more or less blocks than are shown in FIG. 8. In some implementations, one or more of the blocks of method 1000 may, at certain times, be ongoing and/or may repeat.

The method 800 may start at block 862, and continue to block 864, where a detailing engine (e.g., detailing engine 590 from FIG. 5) ejects detailing agent to the build material layer based on the printing instructions (e.g., printing instructions 540 from FIG. 5). At block 866, the method 800 may end.

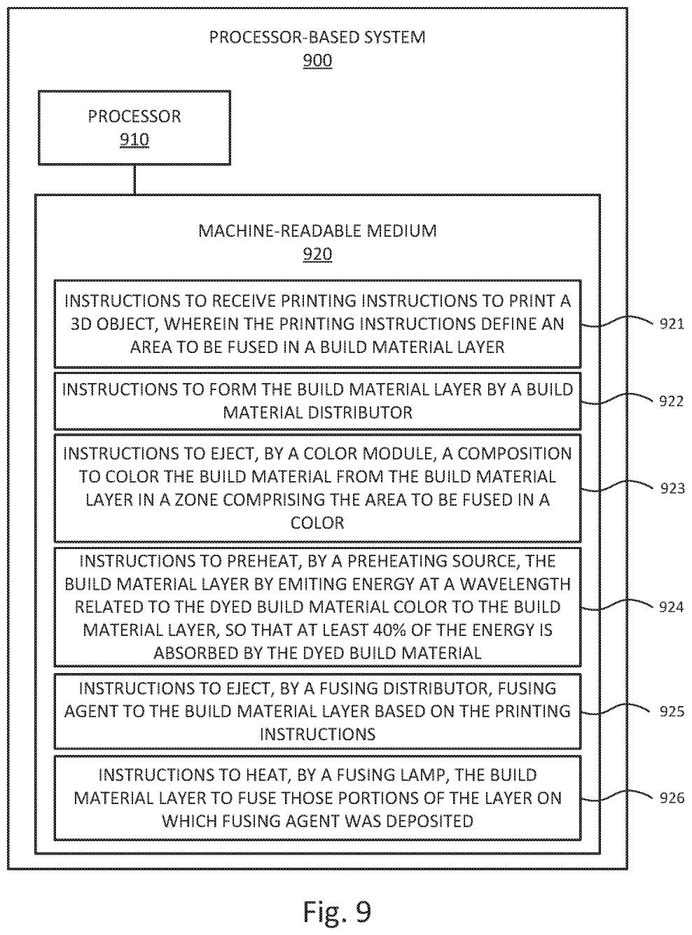

FIG. 9 is a block diagram illustrating an example of a processor-based system 900 to preheat build materials with a light emitting diode array. In some implementations, the system 900 may be or may form part of a printing device, such as an additive manufacturing system. In some implementations, the system 900 is a processor-based system and may include a processor 910 coupled to a machine-readable medium 920. The processor 910 may include a single-core processor, a multi-core processor, an application-specific integrated circuit (ASIC), a field programmable gate array (FPGA), and/or any other hardware device suitable for retrieval and/or execution of instructions from the machine-readable medium 920 (e.g., instructions 921, 922, 923, 923, 926 and 926) to perform functions related to various examples. Additionally, or alternatively, the processor 910 may include electronic circuitry for performing the functionality described herein, including the functionality of instructions 921, 922, 923, 924, 925 and/or 926. With respect of the executable instructions represented as boxes in FIG. 9, it should be understood that part or all of the executable instructions and/or electronic circuits included within one box may, in alternative implementations, be included in a different box shown in the figures or in a different box not shown.

The machine-readable medium 920 may be any medium suitable for storing executable instructions, such as a random-access memory (RAM), electrically erasable programmable read-only memory (EEPROM), flash memory, hard disk drives, optical disks, and the like. In some example implementations, the machine-readable medium 920 may be a tangible, non-transitory medium, where the term “non-transitory” does not encompass transitory propagating signals. The machine-readable medium 920 may be disposed within the processor-based system 900, as shown in FIG. 9, in which case the executable instructions may be deemed “installed” on the system 900. Alternatively, the machine-readable medium 920 may be a portable (e.g., external) storage medium, for example, that allows system 900 to remotely execute the instructions or download the instructions from the storage medium. In this case, the executable instructions may be part of an “installation package”. As described further herein below, the machine-readable medium may be encoded with a set of executable instructions 921-926.

Instructions 921, when executed by the processor 910, may receive printing instructions (e.g., printing instructions 140 from FIG. 1) to print a 3D object, wherein the printing instructions define an area to be fused in the build material layer. Instructions 922, when executed by the processor 910, may form the build material layer by a build material distributor (build material distributor 110 from FIG. 1). Instructions 923, when executed by the processor 910, may cause the processor 910 to eject, by a color module (e.g., color module 160 from FIG. 1), a composition to color the build material from the build material layer in a zone comprising the area to be fused in a color. Instructions 924, when executed by the processor 910, may cause the processor 910 to preheat, by an preheating source (e.g., preheating source 120 from FIG. 1), the build material layer by emitting energy at a wavelength related to the dyed build material color to the build material layer, so that at least 40% of the energy is absorbed by the dyed build material. Instructions 925, when executed by the processor 910, may cause the processor 910 to eject, by a fusing distributor (e.g., fusing distributor 470 from FIG. 4), fusing agent to the build material layer based on the printing instructions. Instructions 926, when executed by the processor 910, may cause the processor 910 to heat, by a fusing lamp (e.g., fusing lamp 480 from FIG. 4), the build material layer to fuse those portions of the layer on which fusing agent was deposited by raising the temperature of the dyed build material above its melting point.

The machine-readable medium 920 may include further instructions. For example, instructions that when executed by the processor 910, may cause the processor 910 to eject, by a detailing engine (e.g., detailing engine 590 from FIG. 5), detailing agent to the build material layer based on the printing instructions.

The above examples may be implemented by hardware, or software in combination with hardware. For example, the various methods, processes and functional modules described herein may be implemented by a physical processor (the term processor is to be implemented broadly to include CPU, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processors, or a combination thereof.

The drawings in the examples of the present disclosure are some examples. It should be noted that some units and functions of the procedure are not necessarily essential for implementing the present disclosure. The units may be combined into one unit or further divided into multiple sub-units. What has been described and illustrated herein is an example of the disclosure along with some of variations. The terms, descriptions and figures used herein are set forth by way of illustration. Many variations are possible within the scope of the disclosure, which is intended to be defined by the following claims and their equivalents.

What it is claimed is:

1. An additive manufacturing system comprising:
a build material distributor to form build material layers;
a color module to eject a composition that dyes a build material layer with a color;
a preheating source to emit energy at a wavelength related to the dyed build material color so that at least 40% of the energy is absorbed by the dyed build material; and
a controller to:
receive printing instructions to print a three-dimensional (3D) object, wherein the printing instructions define an area to be fused in a build material layer,
instruct the build material distributor to form the build material layer,
instruct the color module to eject the composition to color the build material from the build material layer in a zone comprising the area to be fused, and
control the preheating source to emit energy to preheat the build material layer.

2. The apparatus of claim 1, wherein the color module comprises a print head to apply the composition to the zone comprising the area to be fused from the build material layer.

3. The apparatus of claim 1, the controller to instruct the color module to apply the composition to color the build material in a substantially rectangular shape being the area to be fused substantially placed in the middle.

4. The apparatus of claim 1, the controller to instruct the color module to apply the composition to color the build material in an extended shape as the area to be fused being the area to be fused substantially placed in the middle.

5. The apparatus of claim 1, wherein the area to be fused comprises a plurality of areas to be fused, the controller to instruct the color module to apply the composition to color the build material in a substantially rectangular shape, the plurality of areas to be fused being placed therein.

6. The apparatus of claim 1, wherein the area to be fused comprises a plurality of areas to be fused, the controller to instruct the color module to apply the composition to color the build material in a plurality of preheating zones, wherein each preheating zone has an extended shape from a corresponding area to be fused being each of the areas to be fused substantially placed in the middle of each preheating zone.

7. The apparatus of claim 1, wherein the preheating source is either:
a one-dimensional Light Emitting Diode (LED) array comprising one or more LED lights to emit energy that spans substantially the full width of the build material layer and is moveable along the length of the build material layer; or
a two-dimensional LED array comprising one or more LED lights to emit energy that spans substantially the full width and length of the build material layer.

8. The apparatus of claim 1, wherein the preheating source is to emit energy from the group comprising blue light and/or ultraviolet (UV) light, wherein:
the blue light is to emit energy at a wavelength comprised in the range defined from about 450 nanometers (nm) to about 495 nm, and
the UV light is to emit energy at a wavelength of less than 400 nm.

9. The apparatus of claim 1, wherein the color module is to eject the composition in the zone comprising the area to be fused from the build material layer in a color selected from the group comprising yellow and/or orange.

10. The apparatus of claim 1, comprising a fusing module comprising:
a fusing distributor to eject fusing agent to the build material layer based on the printing instructions; and
a fusing lamp to heat the build material layer.

11. The apparatus of claim 10, comprising a detailing agent engine to eject detailing agent to the build material layer based on the printing instructions.

12. A method comprising:
receiving printing instructions to print a three-dimensional (3D) object, wherein the printing instructions define an area to be fused in a build material layer;
forming the build material layer by a build material distributor;
ejecting, by a color module, a composition to color the build material from the build material layer in a zone comprising the area to be fused in a color;
pre-heating, by a preheating source, the build material layer by emitting energy at a wavelength related to the dyed build material color to the build material layer, so that at least 40% of the energy is absorbed by the dyed build material;
ejecting, by a fusing distributor, fusing agent to the build material layer based on the printing instructions; and
heating, by a fusing lamp, the build material layer to fuse those portions of the layer on which fusing agent was deposited.

13. The method of claim 12 wherein the preheating by the preheating source comprises emitting energy from the group comprising blue light and/or ultraviolet (UV) light, wherein:
the blue light emits energy at a wavelength comprised in the range defined from about 450 nanometers (nm) to about 495 nm, and
the UV light emits energy at a wavelength of less than 400 nm.

14. The method of claim 12 wherein the ejecting by the color module comprises ejecting the composition in the zone comprising the area to be fused in a color selected from a group comprising yellow and/or orange.

15. A non-transitory machine readable medium storing instructions executable by a processor, the non-transitory machine-readable medium comprising:
instructions to receive printing instructions to print a three-dimensional (3D) object, wherein the printing instructions define an area to be fused in a build material layer:
instructions to form the build material layer by a build material distributor;
instructions to eject, by a color module, a composition to color the build material from the build material layer in a zone comprising the area to be fused in a color;
instructions to pre-heat, by a preheating source, the build material layer by emitting energy at a wavelength related to the dyed build material color to the build material layer, so that at least 40% of the energy is absorbed by the dyed build material;
instructions to eject, by a fusing distributor, fusing agent to the build material layer based on the printing instructions; and
instructions to heat, by a fusing lamp, the build material layer to fuse those portions of the layer on which fusing agent was deposited.
